(19) United States
(12) Patent Application Publication
(10) Pub. No.: US 2002/0116870 A1
(43) Pub. Date: Aug. 29, 2002

(54) Automatic houseplant watering apparatus for homes and offices

(76) Inventor: Carl Wan-Cheng Chen, Danville, CA (US)

Correspondence Address: CARL WAN-CHENG CHEN, 165 TENBY TERRACE, DANVILLE, CA, 94506, US

(21) Appl. No.: 09/683,937

(22) Filed: Mar. 5, 2002

(51) Int. Cl. A01G 29/00

(52) U.S. Cl. 47/48.5

(57) ABSTRACT

An automatic houseplant watering apparatus for homes and offices to work with existing planter and decorative containers without modification, comprising a programmable timer, a water reservoir, a micro submersible pump, a connecting tube, a soaker line, multiple anchoring stakes, and a siphon tube. The watering schedule can be programmed for any day of the week, any time of the day, and any duration of watering. The water reservoir can be refilled periodically without changing the watering schedule. The siphon can be used to connect an auxiliary water tank to the water reservoir for several months of extended vacation.

### BACKGROUND OF THE INVENTION

1. Background Field of Invention

This invention relates to an automatic houseplant watering apparatus for homes and offices.

2. Background Description of Prior Art

It has been said that invention starts with a need. My home and office lost many houseplants in the past. The nurserymen diagnosed that our plants died because of over watering. They said that the houseplants favor a wet and dry cycle. We needed to touch the soil with fingers and to water the plant only when it felt dry. With the proper watering technique, our houseplants began to thrive until we went on a vacation. An unexpected delay in returning home caused our cherish houseplants to die for lack of water. We have since been searching for an automatic houseplant watering system with certain specifications.

There are a large number of patents for the device to water a plant, when the caretaker is on vacation. U.S. Pat. No. 6,134,833 to Bachman and Mehta (2000) is for the self-watering plant container. Based on this patent, Natural Spring Controlled Watering Planter became commercially available. The planter is made of two shells, snapped together to form the sidewall of the pot. Between the inner and outer shells is an airtight water reservoir with a plug on the top for water filling. At the bottom of the planter, there are holes, which allow water to seep from the water reservoir to the soil medium. The control mechanism is by a hydrophilic polyethylene sensor for soil moisture. The sensor is placed inside a plastic tube and buried near the root ball of the plant. The tube is connected to the top of water reservoir. When the soil is dry, the dry sensor lets air pass through the tube and into the water reservoir. This increases the water pressure in the reservoir, which forces water through the water holes to the planter. The water starts to wet the soil from bottom to top. The wet sensor stops the air passage to the water reservoir. The air pressure in the water reservoir gradually drops below one atmosphere, which stops the release of water from the reservoir.

The disadvantages of the apparatus are: (a) it cannot work on a houseplant in its existing pot and decorative container, (b) the single manufacturer makes only few styles of self watering plant containers, which are not decoratively attractive, (c) the transportation cost for the bulky containers is high, (d) it requires the reporting of the houseplant with a special mix of soils to conduct water, (e) the buried soil moisture sensor can be fouled by bacterial growth, (f) the water holes at the bottom may be interfered by the root growth, (g) it is difficult to maintain the moisture sensor and water holes underneath the soil, (h) watering occurs during the period of water refilling regardless of the need, (i) the maximum length of time for unattended use is only one month.

U.S. Pat. No. 3,758,987 to Crane (1973) reveals a double walled planter that stores water between the walls. U.S. Pat. 4,329,815 to Secrest (1982) reveals another self-controlled watering planter device. Both patents use a soil moisture sensor to let the air pass to the reservoir, which releases water to the planter. They worked on the same principle as U.S. Pat. No. 6,134,833 and suffered the same disadvantages.

U.S. Pat. No. 3,775,904 to Peters (1973) reveals a self-watering flowerpot that has double walls. The control for the release of water from the reservoir is not by a soil moisture sensor. A cavity and a channel, both open downward, are placed at the bottom of the pot. An aperture in the cavity allows water to seep into the soil by capillary action. The released water creates a vacuum in the reservoir and stops the water flow. The vacuum is relieved when the soil is sufficiently dry to let air permeate through the aperture and to the water chamber. Other patents for self-watering planters include U.S. Pat. Nos. 4,864,711 to Fah (1989), 4,819,375 to Baumgartner at al. (1989), 4,885,870 to Fong (1989), and 4,916,858 to Hobson (1990). All the self-watering planters share the same disadvantages as described earlier for U.S. Pat. No. 6,134,833.

U.S. Pat. Nos. 5,956,899 to DiOrio (1999) revealed a self-watering device based on the same principle as 6,134,833 and 4,329,815. The DiOrio Patent does not have a planter. It provides a separate airtight reservoir, which is hanged on the sidewall of the container. A soil moisture sensor can be buried at different height levels of the soil. The reservoir has an outlet tube at the bottom of the reservoir. The outlet tube is connected to the bottom soil of the pot. When the moisture senor detects dryness of soil, it lets air pass through the venting tube to the reservoir. The atmospheric pressure forces water to flow from reservoir to the bottom soil of the planter. When the soil becomes wet, the sensing device shuts the airflow, which in turn shuts the water flow.

The DiOrio Patent can work with the existing pot and container of a houseplant. However, it has the same maintenance problems for the soil moisture sensor and outlet tube. The other disadvantage is the need to drill a hole through the sidewall of the decorative container and the planter. This can damage the decorative container.

U.S. Pat. No. 5,749,170 to Furuta (1998) reveals an automatic water supply device. The device comprises a pot-shaped case, a reverse bowl shape, and a flowerpot with drain holes. The reverse bowl is placed at the bottom. The flow pot is placed above the reverse bowl. The water is poured into the case. The water flows into the reverse bowl, which has an air gap on the dome. Air pressure is applied to the reverse bowl and to push the water upward to the space between the case and flowerpot. The water wets the soil from bottom up. The watering sequence is controlled by two means. A timer can be set to drive an air pump, which pump air to the reverse bowl. A soil moisture sensor can also send a signal to the controller, which operates the air pump. The Furuta device shares the same disadvantages of self-watering planters.

U.S. Pat. No. 4,447,983 to Shinada (1984) disclosed an irrigating apparatus. The apparatus has a liquid container positioned below the planter. The liquid container can be pressurized by an air pump, which may be controlled by a timer. The air pump pressurizes the liquid container and pushes liquid upward to the receiving reservoir at the planter above. The receiving reservoir has a float. With the inflow of liquid from the liquid container, the float rises and pushes open an air valve for the pressurized liquid container below. As claimed; the apparatus is good for hydroponics and hanging plants, not suitable for household plants.

U.S. Pat. No. 4,937,972 to Freitus (1990) reveals a three-compartment plant growth chamber, having an upper compartment for soil and plant, an intermediate compartment for growth solution, and a lower compartment for housing a pump. A water sensor in the upper soil compartment sends a signal to activate the pump that delivers a metered quantity of growth solution from the intermediate compartment to the upper compartment. The excess water is drained back to the intermediate compartment. The device has the same disadvantages of integrated planter systems, discussed earlier. Freitus device can concentrate too much salt by recycling the excess solution.

U.S. Pat. No. 5,502,924 to Lee (1996) reveals a planter assembly having automatic water feeding and drying intervals. The Lee's devise uses a lever system with a float to control the quantity of water transferred from water reservoir to the potting soil and also the length of time for drying period to last before the start of next watering. The device is bulky. It shares the same disadvantages of integrated planter system.

U.S. Pat. No. 5,097,626 to Mordoch (1992) reveals an automatic self-watering system for plants growing in a container. The device has an annular water container hanged on the upper edge of the container. A dryness sensor is inserted into the soil. The dryness sensor opens a valve to release water from the water container to the soil media. The dryness sensor automatically closes the valve when the soil becomes wet. The disadvantages of the device are: (a) the dryness sensor can be fouled by bacteria growth, (b) the size of water tank is limited unless a larger tank is set up on a rack above the container, and (c) there is no distribution system for even application of water to the soil media.

U.S. Pat. No. 4,805,342 was awarded to Jenkins and Marx (1989) for a plant irrigation system. Like the DiOrio patent (U.S. Pat. No. 5,956,899), the apparatus provides a reservoir to place on the side of the planter. The reservoir is pressurized by a separate means to force water to flow from the reservoir to the planter. The system is not automatic. U.S. Pat. Nos. 4,961,285 to Jenkins and Marx (1990) reveals a reservoir design, varied from 4,805,342.

U.S. Pat. No. 5,511,341 was awarded to Payne (1996) for a good neighbor houseplant watering system. The system comprises a reservoir, which has one or two water outlets at the bottom and an air inlet at the top. An adjustable valve is used to regulate the outflow of water from the reservoir. A perforated and threaded plug serves two purposes. It can be unscrewed open to fill water. It can be screwed down or up to adjust the opening of its central bore, which regulates the airflow to the reservoir. By adjusting the control valve for water outflow and/or the control valve for air inflow, Payne claims that the device will deliver a constant slow flow of water to a planter by gravity.

There are many disadvantages of the Payne's device. As shown in the patent drawing, the device is large and bulky. It needs to be mounted on a cart with casters, which is not decoratively attractive. The problem would be worse for a larger houseplant. The large and bulky cart must be elevated above the planter for a gravity flow. Furthermore, the mechanical valves for air and water flows can be worn out easily. The control valves are not reliable for maintaining a constant flow. As the water is drained from the bottom of the reservoir, it creates a vacuum to draw more air into the reservoir. Decreasing the water level in the reservoir will also slow down the flow for the same setting of control valve.

U.S. Pat. No. 4,335,540 to Allen (1982) reveals a combined plant container and watering device. The planter is built with double walls on the side and a bottom with open ports. The outer wall extends further down to sit on a drain pan. The water is stored between the sidewalls. A manually operated pump spray a fine mist of spray on the soil and plant in the container. The disadvantages of Allen's invention are (a) it is not an automatic watering system, (b) it requires a repotting of the plant, and (c) the planter is not decoratively attractive.

U.S. Pat. No. 4,653,529 to Freeman (1987) reveals an intermittent watering device for houseplant. The device has a tray partitioned into two parts by a weir. One side of the tray (the second receptacle) is for a planter with a hole at the bottom. The water reservoir and flow control unit sits on the other side of the tray (the first receptacle). The unit contains a water reservoir and two separate air spaces. The upper air space is directly above the water reservoir. The lower air space is directly above the first receptacle. A vertical tube connects the two air spaces. The water is released from the water reservoir to the first receptacle. The water flows over the weir to the second receptacle. When the water level rises in the first receptacle, the water seals off the vertical tube to prevent airflow from the lower air space to the upper air space. This in turn stops the water release to the first receptacle. When the plant consumes water from the second receptacle, the water from the first receptacle continues to supply the water over the weir. This process continues until the water level in the first receptacle drops to the weir crest. After that, water is retained in the first receptacle to prevent the water from drying up and letting air seeps into the lower air space. When the water in the first receptacle drops to a certain level by evaporation, the vertical tube opens to initiate airflow from the lower air space to the upper air space. This action makes the reservoir to release water to the first receptacle again.

The disadvantage of Freeman's device is that the watering is caused by the evaporation of water from the first receptacle. Since the transpiration of a plant can be higher than the evaporation from water, the plant can experience water stress. The other disadvantage is that the device is very bulky, not decoratively attractive.

U.S. Pat. No. 5,634,342 to Peeters and Berkbigler (1997) reveals an electronic houseplant watering device. The device condenses atmospheric moisture to supply water to the plant. The application of the device is limited. It would not work in air conditioned homes or offices, where air moisture is low.

U.S. Pat. No. 5,848,494 to Spelt (1996) is for a self-watering apparatus for plant. The device has a valve responsive to weight of the potted plant. As the planter losses water by transpiration, it becomes lighter. In response, the device opens the valve to deliver water to the plant. Another device using the weight to control water delivery is U.S. Pat. No. 4,848,029 awarded to Han (1989). The common problem of weight controlled watering device is that the planter needs to be suspended for weighting. That makes the device impractical for homes and offices.

U.S. Pat. No. 3,534,498 to Herrli (1970) reveals a water container with a housing that allows a pot to be positioned at different elevations. For the hydroponics plants, the pot can be submerged. For other plants, the pot is positioned above the water level. A wick transports the water upward to the pot. As the water is used up, however, the water level drops and the plant cannot get sufficient water through the capillary action of the wick.

The prior arts described above do not meet the specifications that I was looking for.

### SUMMARY OF INVENTION

Objects and Advantages

Accordingly, I claim that the objects and advantages of the invention as follow:

1. To provide an automatic houseplant watering apparatus for homes and offices that can work with any existing planter and decorative container without modifications. There is no need to buy an integrated unattractive planter. The users can continue to use their existing decorative container, which may not only be attractive but also of sentimental value to them. There is no need for repotting, which can be a chore in itself.

2. To use modern components that are miniature and space saving. It does not have bulky equipments or a cart to store them, all of which may destroy the home or office decor.

3. To provide a flexibility on the location of the water reservoir. Unlike the gravity feed system, the water reservoir of the apparatus doe not have to be elevated. It can either be hidden behind the planter or made decoratively attractive for open display.

4. To include a modern control device that can be programmed to water the plant on any days of the week, allowing for a wet and dry cycle favored by most houseplants. The periodical refill of the water reservoir should not alter the watering schedule. This prevents the possibility of over watering, which is a common cause of plant mortality.

5. To provide the reservoir capacity a minimum of about one month worth of water for use without attendance. For homeowners on an extended vacation, the apparatus should provide a siphon to connect the water reservoir to an auxiliary water tank of any size.

6. To provide means to deliver a stream of water at a pressure that is suitable for a small diameter soaker line, which would normally require a barb connection to reduce the water pressure from a regular water supply line for outdoor application.

7. To include a soaker line or low pressure sprinklers for even distribution of water to the soil of the planter.

8. To provide a maintenance free apparatus. No important component is buried in the soil of the planter.

### BRIEF DESCRIPTION OF DRAWINGS

FIG. 1 shows the automatic houseplant watering apparatus for homes and offices.

FIG. 2a shows the preferred embodiment of anchoring stakes.

FIG. 2b show an alternative embodiment of anchoring stakes.

FIG. 3 shows the siphon that connects an auxiliary water tank to the water reservoir

### BRIEF DESCRIPTION OF SEQUENCES

2 household electric outlet.

4 digital programmable timer.

10 power cord of a submersible water pump.

12 preferred embodiment of the micro-submersible water pump.

14 water reservoir.

16 connecting tube.

18 auxiliary water tank.

19 siphon tube.

20 preferred embodiment of soaker line.

22 anchoring stakes.

22a side view of the preferred embodiment of anchoring stake.

22b side view of the alternate embodiment of anchoring stake 24 preferred embodiment of the end stopper plug.

30 existing planter of home owner.

32 existing decorative container of home owner.

### DETAILED DESCRIPTION

Description of Preferred and Alternate Embodiments

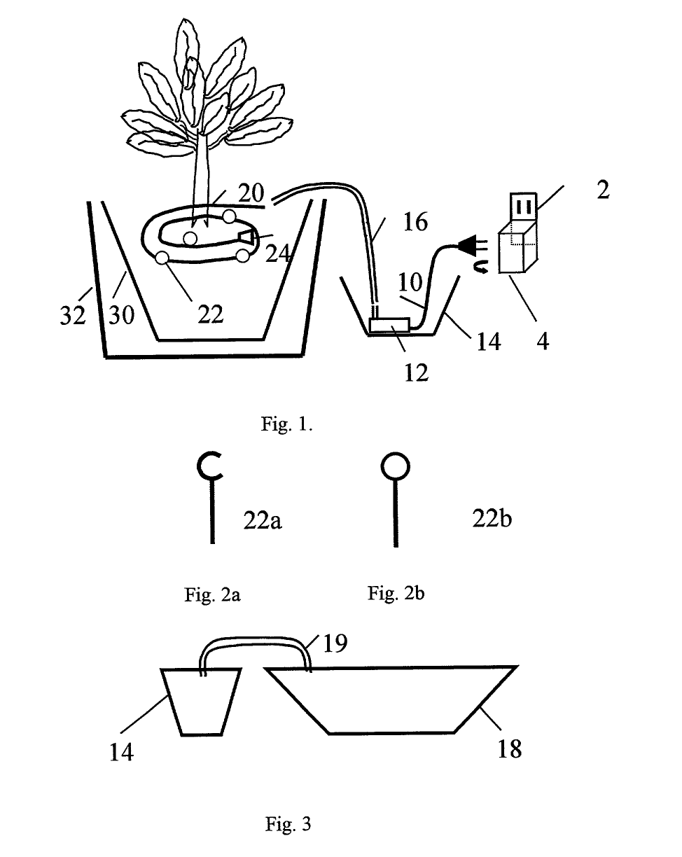

FIG. 1 shows the automatic houseplant watering apparatus for homes and offices that comprises a programmable timer 4, a water reservoir 14, a micro submersible water pump 12, a connecting tube 16, a soaker line 20, a stopper plug 24, and multiple anchoring stakes 22. As shown in FIG. 1, the apparatus can work directly with any existing planter 30 and decorative container 32, without modification. FIG. 2a and FIG. 2b show the side view of the anchoring stake. FIG. 3 shows a siphon tube 19 that can be used to connect the auxiliary tank 18 to the water reservoir 14.

The programmable timer can be mechanical or digital. The preferred embodiment is digital timer 4 for seven-day programming, which is small and reliable. The digital timer 4 is plugged into a household electric outlet 2. The timer is so small that it does not even cover the entire plate of the household electric outlet. The seven-day programming allows the user to set the day or days of the week for a repetitive watering schedule. The digital timer has a battery to keep time, in case there is an interruption of electricity.

The micro submersible water pump 12 has a power cord 10 that plugs into the electric outlet of the digital timer 4. The water pump 12 sits on the bottom of the water reservoir 14, which has a cover to minimize evaporation. The micro pump 12 delivers the water at an appropriate pressure through a connecting tube 16 to the soaker line 20. The soaker line has been designed originally for the outdoor use. A barb connector is normally required to reduce the water pressure from about 120 pounds per square inch in water supply line to about 15 pounds per square inch needed for the soaker line. The use of micro submersible water pump eliminates the need for a barb connection.

The irrigation component can be either a soaker line or low pressure and low flow sprinklers. The preferred embodiment is a small diameter soaker line. The soaker line 20 can be looped around a single stem plant or around and between multiple stemmed palms for drip irrigation. The end of the soaker line needs to be sealed to maintain the water pressure for the soaker line 20. Any method can be used to seal the soaker line. The preferred embodiment is the stopper plug 24. The anchor stakes 22 hold the soaker line 20 in place and keep the looped soaker line 20 in reasonable level for even dripping of water to the soil. The preferred embodiment of anchoring stake has an open head 22a, which allows the soaker line 20 to be snapped on easily. The alternate anchoring stake has a circle head 22b, which allows the soaker line 20 to thread through. The anchoring stakes can be made of any materials. The preferred embodiment is plastic stakes that are maintenance free.

The watering apparatus can work automatically for weeks without attendance. Periodical refill of water does not interfere with the watering schedule. The regular watering schedule prevents over watering, which is often a leading cause of plant mortality.

The caretaker on an extended vacation can attach an auxiliary tank to the water reservoir 14. The preferred embodiment is the siphon tube 19 that can be used to connect a large auxiliary water tank 18 to the water reservoir 14. The apparatus is easy to maintain. There is no component buried in the soil.

Description of Operation

The first step is to install the apparatus as shown in FIG. 1. A little planning would be helpful in deciding where to put the water reservoir 14, which can be placed behind the decorative container 32, beside the decorative container 32, hiding underneath a corner table, or hanging on the rim and in the back of the decorative container 32 with a bracket. The digital timer 4 is plugged into the household electric outlet 2. The power cord 10 of the micro-submersible pump 12 is plugged into the outlet of the timer 4. The outlet of the micro-submersible pump 12 is connected to the soaker line 20 by the connecting tube 16. It is necessary to connect the soaker line 20 at the correct end of the soaker line 20 so that the water will flow in the direction shown on the soaker line. To place the soaker line, first remove the mosses from planter, if any. Loop the soaker line 20 around the stem of the plant or around and between the multiple-stemmed palms, using anchoring stakes 22 to hold the soaker line 20 in place. Adjust the anchoring stakes 22 up or down to keep the soaker line 20 reasonably level. Cut off the excess soaker line 20 and place a stopper plug 24 to the end. Cover the soaker line with the mosses. Fill up the water reservoir 14. That completes the installation.

After the installation, an experiment is conducted to measure the amount of water pumped per minute. To do that, push the “manual on” button of the timer 4 to start the pump 12. After 5 minutes, push off the “manual on” button and measure the volume of water dispensed from the reservoir 14. Use the information to estimate the duration of time needed for watering. The duration of watering can be adjusted up or down in the first few weeks of operation. The duration of watering must also be adjusted for the seasonal change of the plant transpiration.

The next step is to set the timer 4 for the current day of the week and hour and minute of the day. Push the program button and set the days of the week and hour and minute of the day to start the watering. Push the program button again and set the hour and minute of the day to stop the watering. The time to stop watering equals to the time to start plus the duration of time for watering. After that, push the program button to the “automatic” mode. The apparatus will automatically water the plant according to the schedule. Periodically, the user must refill water to the reservoir 14. The refilling will not alter the watering schedule.

The homeowner, who wishes to take an extended vacation, must refill the water reservoir to its full capacity. This should normally be adequate for more than a month of unattended watering. For an extended vacation, the homeowner can place a large bucket of water and connect it to the reservoir 14 with the siphon tube 19.

Conclusion, Ramifications, and Scope

This invention relates to an automatic houseplant watering apparatus for homes and offices. The apparatus is for use with any existing planter and decorative container. The components of the apparatus are small, which are not obstructive to the home and office décor. The equipments are all above ground, which make them easy to maintain. The scope of the invention includes control, water storage, water delivery, and even distribution of water to the single stem plants and multiple-stemmed palms. While the invention has been described with certain embodiments, variations and modifications may be made without departing the spirit and scope of the invention.

1. An automatic houseplant watering apparatus for homes and offices to work with existing planter and decorative container, comprising:
[Claim Reference] a) Programmable control means to set the watering schedule by the days of week, time of day, and duration of watering, which allows for wet and dry periods favored by most houseplants.
[Claim Reference] b) Pumping means to deliver a stream of water at a pressure that is suitable for direct feed to a soaker line.
[Claim Reference] c) Connecting means to feed the water from said pumping means to said soaker line without a barb connector.
[Claim Reference ] d) Means to seal the end of said soaker line to maintain the water pressure necessary for drip irrigation of the plant.

2. The apparatus of claim 1 further includes means to hold said soaker line in place and in a reasonable level position for even distribution of water to the planter soil.

3. The apparatus of claim 1 further includes means to increase the volume of said water storage means by connecting it to an auxiliary water tank for several months of extended vacation.
